(19) United States
(12) Patent Application Publication
(10) Pub. No.: US 2021/0176850 A1
(43) Pub. Date: Jun. 10, 2021

(54) SYSTEMS AND METHODS FOR IMPROVED X-RAY TUBE LIFE

(71) Applicant: Hologic, Inc., Marlborough, MA (US)

(72) Inventor: Guoyun Ru, Danbury, CT (US)

(73) Assignee: Hologic, Inc., Marlborough, MA (US)

(21) Appl. No.: 17/111,764

(22) Filed: Dec. 4, 2020

Related U.S. Application Data
(60) Provisional application No. 62/944,126, filed on Dec. 5, 2019.

(51) Int. Cl. H05G 1/02; H05G 1/58; H01J 35/06

(52) U.S. Cl. CPC H05G 1/02; H01J 35/066; H05G 1/58

(57) ABSTRACT

An x-ray tube having at least one focusing cup and an anode. The x-ray tube may have a first filament positioned in a first location between the focusing cup and the anode, the first filament having a first size, and a second filament positioned in a second location between the focusing cup and anode, the second filament having a second size that is substantially the same as the first size. The x-ray tube may also include a switching mechanism configured to engage the second filament upon failure of the first filament.

### CROSS-REFERENCE TO RELATED APPLICATIONS

This application claims the benefit of U.S. Provisional Application No. 62/944,126, titled, “SYSTEMS AND METHODS FOR IMPROVED X-RAY TUBE LIFE,” filed Dec. 5, 2019, which application is incorporated herein by its reference in its entirety.

### BACKGROUND

Imaging based on the use of x-rays is commonplace in medical imaging technology, such as mammography or tomosynthesis systems. The x-rays used in such imaging technology are often generated through the use of an x-ray tube. The x-ray tube, however, has a limited lifetime. When the x-ray tube reaches the end of its lifetime, the tube must be replaced. The replacement process can be expensive, time consuming, and delay medical imaging procedures for patients.

### SUMMARY

The present technology relates to systems and methods for increasing the lifetime of an x-ray tube. In an aspect, the technology relates to an x-ray tube that includes a focusing cup and an anode. The x-ray tube further includes a first filament positioned in a first location between the focusing cup and the anode, the first filament having a first size; a second filament positioned in a second location between the focusing cup and anode, the second filament having a second size that is substantially the same as the first size; and a switching mechanism configured to engage the second filament upon failure of the first filament. In an example, the x-ray tube further includes a first electrode and a second electrode positioned between the second filament and the anode, and the first electrode is positioned opposite an electron beam path from the second electrode. In another example, the first electrode and the second electrode are configured to, when a first control signal is applied across the first and second electrode, generate an electric field that moves an electron beam in a first direction. In yet another example, the first filament is configured to generate a first electron beam having a first focal spot on the anode; the second filament is configured to generate a second electron beam; and the control signal is configured to move the second electron beam such that the second electron beam has a second focal spot on the anode that is substantially the same as the first focal spot.

In a further example, the x-ray tube further includes a third electrode and a fourth electrode, wherein the third electrode and the fourth electrode are configured to, when a second control signal is applied across the third and the fourth electrode, generate an electric field that moves the electron beam in a second direction. In still another example, the switching mechanism is a mechanical switch. In still yet another example, the switching mechanism includes at least one transistor or relay configured to automatically engage the second filament upon the failure of the first filament.

In another aspect, the technology relates to an x-ray tube that includes a first focusing cup, a second focusing cup, and an anode. The x-ray tube further includes a first filament located between the first focusing cup and the anode; a second filament positioned between the second focusing cup and the anode; and a switching mechanism configured to engage the second filament upon failure of the first filament. In an example, the x-ray tube further includes a first electrode and a second electrode positioned between the second filament and the anode, wherein the first electrode is positioned opposite an electron beam path from the second electrode. In another example, the first electrode and the second electrode are configured to, when a first control signal is applied across the first and second electrode, generate an electric field that moves an electron beam in a first direction. In yet another example, the first filament is configured to generate a first electron beam having a first focal spot on the anode; the second filament is configured to generate a second electron beam; and the control signal is configured to move the second electron beam such that the second electron beam has a second focal spot on the anode that is substantially the same as the first focal spot.

In a further example, the first filament is configured to generate a first electron beam having a first focal spot on the anode; the second filament is configured to generate a second electron beam; and the first focusing cup and the second focusing cup are positioned such that the second electron beam has a second focal spot on the anode that is substantially the same as the first focal spot. In still another example, the switching mechanism is a mechanical switch.

In another aspect, the x-ray tube includes an anode, a focusing cup, an electron emitting block positioned adjacent to the focusing cup and between the focusing cup and the anode, and a laser configured to emit a laser beam towards the electron emitting block. In an example, the laser is a semiconductor laser bar. In another example, the semiconductor laser bar is housed entirely within the x-ray tube. In yet another example, the electron emitting block is primarily made from tungsten. In still another example. the laser beam has a wavelength of about 272 nm or less. In a further example, the electron emitting block has a thickness of at least 1 mm. In yet another example, the electron emitting block has a surface area facing the laser that is greater than about 8 mm.

In another aspect, the technology relates to a method for producing x-rays from an x-ray tube. The method includes receiving a first activation request for the x-ray tube; activating a first filament in the x-ray tube to generate a first x-ray imaging beam; receiving an indication that the first filament has failed; based on the indication that the first filament has failed, engaging a second filament in the x-ray tube; receiving a second activation request for the x-ray tube; and activating a second filament in the x-ray tube to generate a second x-ray imaging beam that is substantially similar the first x-ray imaging beam. In an example, activating the first filament comprises applying a voltage across the first filament. In another example, activating the second filament comprises applying a voltage across the second filament. In yet another example, engaging the second filament comprises switching a mechanical switch. In still another example, the indication that the first filament has failed is a trigger signal generated based on a high resistance of the first filament. In a further example, the method includes activating a control signal applied across at least one pair of electrodes positioned opposite an electron beam path of the x-ray tube.

In another example, the control signal is activated concurrently with the activation of the second filament. In yet another example, activation of the first filament causes an emission of electrons from the first filament that accelerate towards an anode of the x-ray tube which causes the production of x-rays that form the first x-ray imaging beam. In still another example, the method includes generating a medical image based on the second x-ray imaging beam.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

FIG. 1A is a schematic of an example imaging system.

FIG. 1B is a perspective view of the imaging system of FIG. 1A.

FIG. 2A depicts an example of an x-ray tube having multiple filaments.

FIG. 2B depicts an example arrangement of electrodes in an example x-ray tube.

FIG. 3 depicts another example of an x-ray tube having multiple filaments.

FIG. 4 depicts an example of an x-ray tube having a cathode heated by a laser.

FIG. 5 depicts an example method for controlling an x-ray tube.

FIG. 6 depicts an example of a suitable operating environment for use with the present examples.

### DETAILED DESCRIPTION

As discussed above, x-ray tubes in medical imaging systems have limited lifetimes. The limited lifetime of x-ray tubes is often due to the high heat and high voltages that are generally required for the operation of an x-ray tube. The high heat and voltages cause the components of the x-ray tube to break down and eventually fail. When the x-ray tube fails, it must be replaced. Replacement of an x-ray tube is a high cost for multiple reasons. First, the cost of the tube itself is often significant. In addition, when an x-ray tube is replaced, the x-ray tube generally must be realigned and the medical imaging system needs to be recalibrated. In some cases, the reinstallation process may cause an examination room or medical imaging system to be unavailable for several days, leading to delayed examinations and imaging of patients. Accordingly, improving the lifetime of an x-ray tube is desired.

Based on analysis of past x-ray tube failures, the primary reason for failure of an x-ray tube is a failed or broken filament. As discussed further below, in some x-ray tubes a filament is used to generate electrons that are accelerated towards an anode of the x-ray tube. During operation of the x-ray tube, the filament may be heated to temperatures greater than 2000 degrees Celsius for thermionic electron emission to occur. The high heat degrades the filament and may cause the filament material to evaporate gradually. The degradation of the filament ultimately causes the filament to break. The size of the filament has been traditionally limited by a desired focal spot size on the anode. Accordingly, simply increasing the size of the filament to increase the lifetime of the x-ray tube is often not an option.

The present technology increases the lifetime of an x-ray tube through the use of multiple filaments or through the use of a laser for heating a cathode of an x-ray tube. For example, an x-ray tube may be provided with two filaments for generating electrons. When the first filament fails, the second or back-up filament may be engaged. Engaging the second filament may be controlled mechanically, such as through a switch, or electronically through control software/firmware or other electronics. Because the filaments must be located at different positions within the x-ray tube, an additional control signal may be applied when the second filament is engaged to preserve a substantially similar focal spot on the anode as produced by the first filament.

In other examples, the filament of the x-ray tube may be replaced by an electron-emitting block of material configured to emit electrons when heated. The electron-emitting block is heated via a laser, such as a semiconductor laser bar, rather than via an electrical current. The use of the laser allows for the electron-emitting block to be a larger size than the filament, leading to a longer lifetime for the x-ray tube, while still allowing for the area emitting electrons to remain a similar size as a filament by controlling the profile of the laser beam and spot size.

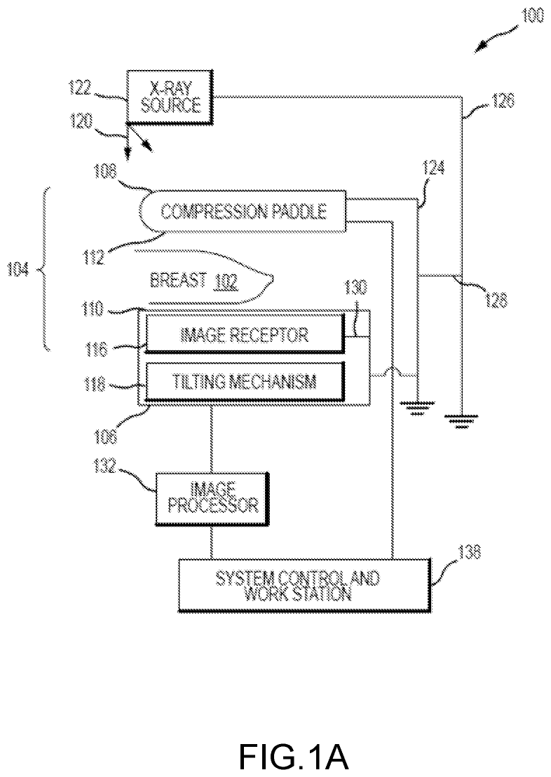

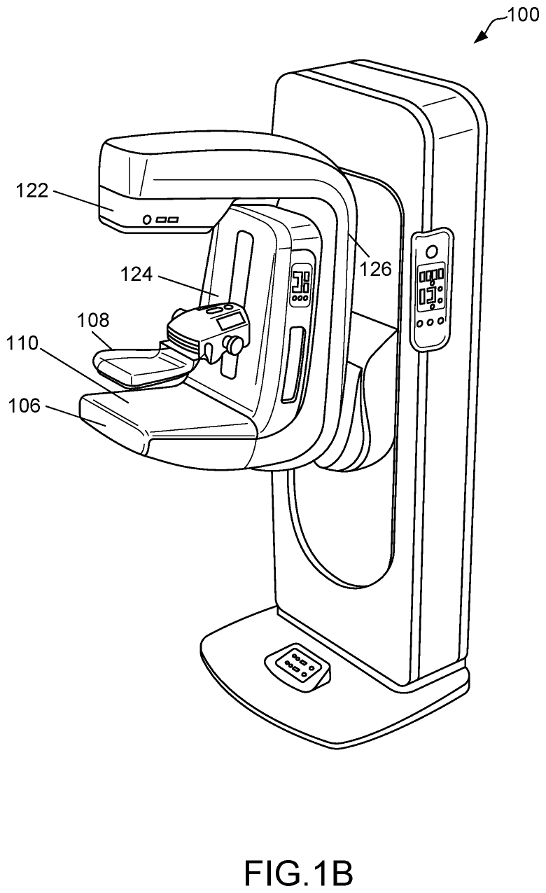

FIG. 1A is a schematic view of an exemplary imaging system 100. FIG. 1B is a perspective view of the imaging system 100. Referring concurrently to FIGS. 1A and 1B, the imaging system 100 immobilizes a patient's breast 102 for x-ray imaging (either or both of mammography and tomosynthesis) via a breast compression immobilizer unit 104 that includes a static breast support platform 106 and a moveable compression paddle 108. The breast support platform 106 and the compression paddle 108 each have a compression surface 110 and 112, respectively, that move towards each other to compress and immobilize the breast 102. In known systems, the compression surface 110, 112 is exposed so as to directly contact the breast 102. The platform 106 also houses an image receptor 116 and, optionally, a tilting mechanism 118, and optionally an anti-scatter grid. The immobilizer unit 104 is in a path of an imaging beam 120 emanating from x-ray source 122, such that the beam 120 impinges on the image receptor 116.

The immobilizer unit 104 is supported on a first support arm 124 and the x-ray source 122 is supported on a second support arm 126. For mammography, support arms 124 and 126 can rotate as a unit about an axis 128 between different imaging orientations such as CC and MLO, so that the system 100 can take a mammogram projection image at each orientation. In operation, the image receptor 116 remains in place relative to the platform 106 while an image is taken. The immobilizer unit 104 releases the breast 102 for movement of arms 124, 126 to a different imaging orientation. For tomosynthesis, the support arm 124 stays in place, with the breast 102 immobilized and remaining in place, while at least the second support arm 126 rotates the x-ray source 122 relative to the immobilizer unit 104 and the compressed breast 102 about the axis 128. The system 100 takes plural tomosynthesis projection images of the breast 102 at respective angles of the beam 120 relative to the breast 102.

Concurrently and optionally, the image receptor 116 may be tilted relative to the breast support platform 106 and in sync with the rotation of the second support arm 126. The tilting can be through the same angle as the rotation of the x-ray source 122, but may also be through a different angle selected such that the beam 120 remains substantially in the same position on the image receptor 116 for each of the plural images. The tilting can be about an axis 130, which can but need not be in the image plane of the image receptor 116. The tilting mechanism 118 that is coupled to the image receptor 116 can drive the image receptor 116 in a tilting motion. For tomosynthesis imaging and/or CT imaging, the breast support platform 106 can be horizontal or can be at an angle to the horizontal, e.g., at an orientation similar to that for conventional MLO imaging in mammography. The system 100 can be solely a mammography system, a CT system, or solely a tomosynthesis system, or a “combo” system that can perform multiple forms of imaging. An example of such a combo system has been offered by the assignee hereof under the trade name Selenia Dimensions.

Whether operating in a mammography or a tomosynthesis mode, the system images the breast by emitting an x-ray beam 120 from the x-ray source. The x-ray beam 120 passes through the breast 102 where it is detected by the image receptor 116. The image receptor 116 may include a plurality of pixels that detect the intensity of the x-ray beam 120 at a plurality of locations after the x-ray beam has passed through the breast 102. The attenuation of the x-ray beam 120 as it passes through the breast 102 changes depending on the structures of the breast 102. Accordingly, images of the breast may be produced from the detected x-ray beam 120. For instance, the image receptor 116 produces imaging information in the form of electric signals, and supplies that imaging information to an image processor 132 for processing and generating x-ray images of the breast 102. A system control and work station unit 138 including software controls the operation of the system and interacts with the operator to receive commands and deliver information including images of the breast 102. The system control and work station unit 138 may also include software for controlling the operation of the x-ray source 122.

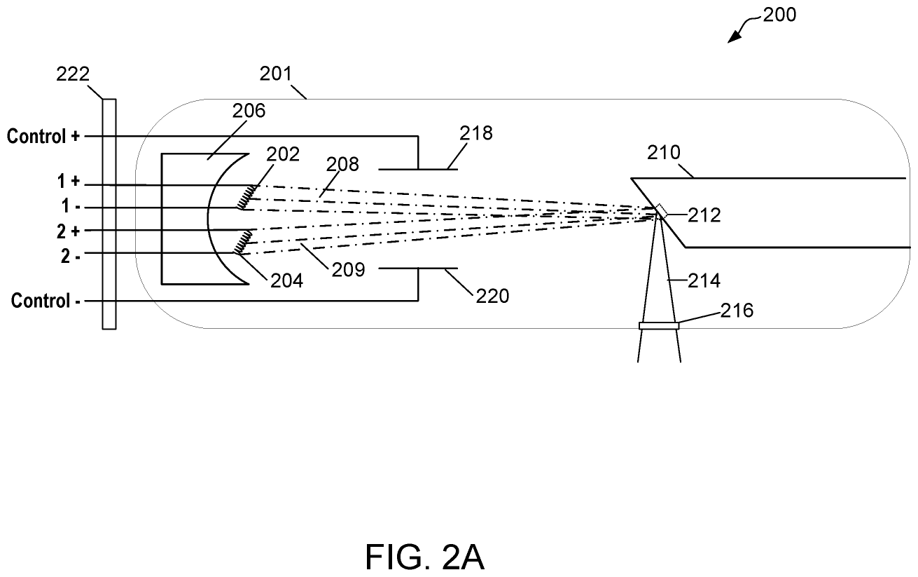

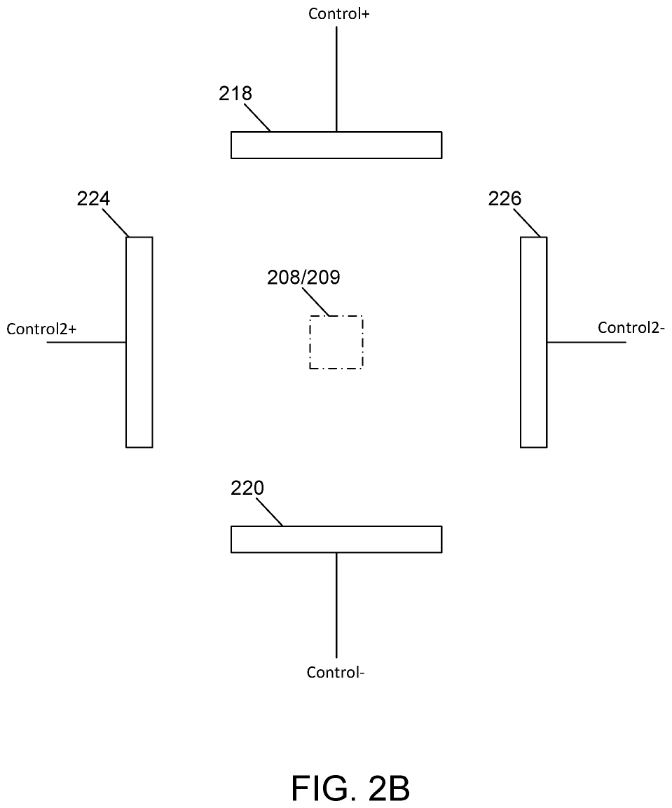

FIG. 2A depicts an example of an x-ray tube 200 having multiple filaments 202, 204. The x-ray tube 200 may be included as at least part of the x-ray source 122 discussed above. The x-ray tube 200 includes tube body 201 housing a cathode assembly including a first filament 202, a second filament 204, and a focusing cup 206. The first filament 202 and the second filament 204 may be placed adjacent to the focusing cup 206 and between the focusing cup and an anode 210. The first filament 202 and the second filament 204 may be made from a material with a high melting point, such as tungsten. A voltage or signal may be applied across the first filament 202 via wires connected to each end of the first filament 202, indicated by the 1+ for the positive connection to the first filament 202 and the 1− for the negative connection to the first filament 202. When the signal or voltage is applied across the first filament 202, a current flows through the first filament 202 which heats the first filament 202 and causes electrons to be emitted from the first filament 202. Due a voltage difference between the cathode assembly and the anode 210, the electrons emitted from the first filament 202 are accelerated towards the anode 210. The accelerated electrons form an electron beam 208 that travels along an electron beam path. The electron beam 208 impacts the anode 210, which causes the emission of x-rays 214 from the anode 210. The x-rays 214 exit the x-ray tube body 201 through a tube window 216. The x-rays 214 that exit through the window 216 form the x-ray beam that is used for imaging, such as x-ray beam 120 discussed above with reference to FIGS. 1A-1B.

The area in which the electron beam 208 impacts the anode 210 is referred to as the focal spot 212. The size of the focal spot 212 relates to the resolution desired for the imaging process. For instance, a small focal spot 212 may be used where high resolution of a small area is desired. The location of the focal spot 212 on the anode 210, as well as the angle of the anode 210, also has an effect on the direction of the x-rays 214 produced from the anode 210. The size and location of the focal spot 212 may be controlled or modified by the focusing cup 206. For instance, the focusing cup 206 may include a negative charge that repels the electrons emitted from the first filament 202. That charge, the distribution of that charge, and the shape of the focusing cup 206 may be selected or configured to direct the electrons emitted from the first filament 202 to the focal spot 212 on the anode 210.

When the first filament 202 fails, the second filament 204 may be engaged. Engaging the second filament 204 may be engaged through a switching mechanism 222. The switching mechanism 222 may be located outside of the tube body 201. The switching mechanism 222 may include a mechanical switch that allows for switching between the first filament 202 and the second filament 204. For example, the voltage applied across the first filament 202 may be the same voltage that is applied across the second filament 204. In such examples, a switch may be used to connect the terminals of the second filament 204 to the voltage source rather than the terminals of the first filament 202. In other examples, engaging the second filament 204 may be controlled electronically through control software/firmware or other electronics, such as transistors and/or relays that may be included in the switching mechanism 222. When the first filament 202 fails, current is prevented from flowing across the first filament 202 (or a small amount of current is able to flow due to a high resistance of the failed filament 202). The lack of current flowing when a voltage is applied across the failed first filament 202 may be detected and used as a trigger signal to engage or switch to the second filament 204. The trigger signal may be processed by software or firmware in a medical imaging system, which may then cause the second filament 204 to engage. The trigger signal may also be used to engage the second filament without the use of software or firmware. For instance, the trigger signal may be provided to one or more transistors and/or relays that switch the connection of the voltage source from the terminals of the first filament 202 to the terminals of the second filament 204.

Similar to the operation of the first filament 202, a voltage or signal may be applied across the second filament 204 via wires or terminals connected each end of the second filament 204, indicated by the 2+ for the positive connection to the second filament 204 and the 2− for the negative connection to the second filament 204. When the signal or voltage is applied across the second filament 204, a current flows through the second filament 204 which heats the second filament 204 and causes electrons to be emitted from the second filament 204. Due the voltage difference between the cathode assembly and the anode 210, the electrons emitted from the second filament 204 are accelerated towards the anode 210. The accelerated electrons from the second filament 204 also form an electron beam 209 that impacts the anode 210 and generates x-rays 214.

Due to the difference in location between the first filament 202 and the second filament 204, however, the electron beam 209 generated by the second filament 204 flows in a different direction than, or is offset from, the electron beam 208 generated by the first filament 202. Accordingly, without additional manipulation, the electron beam 209 produced by the second filament 204 produces a different focal spot 212 (in size and/or location) on the anode 210. Having a different focal spot 212 on the anode 210 may be undesirable because the emitted x-ray beam 214 would have different characteristics that may require physical movement of the x-ray tube 200 in the medical imaging system to realign the x-rays 214 with the detector or receptor of the medical imaging system. The present technology helps eliminate the need for physical movement of the x-ray tube 200 by including a set of electrodes 218, 220 on which a control signal may be applied. The control signal may applied across wires or terminals connected to the electrodes 218, 220 as depicted by the Control+ and Control− in FIG. 2A. The first electrode 218 may be positioned opposite the electron beam path from the second electrode 220.

When the control signal is applied across the electrodes 218, 220, an electric field is generated between the electrodes 218, 220. That electric field interacts with the electrons in the electron beam 208 due to the negative charge of the electrons in the electron beam 208. Depending on control signal, the electrons in the electron beam may either be drawn towards the first electrode 218 or the second electrode. By manipulating the control signal applied across the electrodes 218, 220, the location that the electron beam 208 impacting the anode 210 may altered. Thus, the location of the focal spot 212 may be altered. In some examples, the electrodes 218, 220 may be placed either inside or outside the tube body 201. In other examples, the electrodes 218, 220 may be replaced with a single electromagnet that may be controlled via a similar control signal. Activation of the electromagnet causes a magnet field that may be used to also the electron beams 208, 209.

The control signal may be configured to alter the electron beam 209 emitted from the second filament 204 such that the resultant focal spot 212 for the second filament 204 is substantially the same as the focal spot 212 for the electron beam 208 produced from the first filament 202. In some examples where the first filament 202 and the second filament 204 are the same size, the focal spot 212 generated from the first filament 202 and the second filament 204 may inherently be the same size but located in different positions on the anode 210 when no control signal is present. Accordingly, a proper control signal may be used to shift the location of the electron beam 209. The proper control signal may be determined mathematically due to the geometry of the components of the x-ray tube 200 and the relative locations of the first filament 202 and the second filament 204. The proper control signal may also be determined experimentally by detecting a baseline focal spot 212 location for the second filament 204 and iteratively adjusting the control signal until the focal spot 212 for the electron beam 209 from the second filament 204 is substantially the same as the focal spot 212 for the electron beam 208 from the first filament 202. In some examples, the control signal may be a constant direct current (DC) voltage between the two electrodes 218, 220. In other examples, the control signal may be a changing signal causes the formation of an electromagnetic field between the two electrodes 218, 220.

The control signal may be initiated when the second filament 204 is engaged. For example, when the switching mechanism 222 engages the second filament 204, the switching mechanism may also connect the terminals of the electrodes 218, 220 to a control signal source that generates the control signal. For instance, such a connection may be made through a mechanical switch. The connection may also be made through one or more transistors and/or relays. In some examples, the terminals of the electrodes 218, 220 may be more permanent and the control signal source is activated when the second filament 204 is engaged. For instance, the control signal source may be activated by the trigger signal generated when the first filament 202 fails.

In other examples, the control signal and the electrodes 218, 220 may be used to also control or manipulate the electron beam 208 generated from the first filament 202. For instance, the control signal and electrodes 218, 220 may operate to manipulate both the electron beam 209 from the second filament 204 as well as the electron beam 208 from the first filament 202. Both electron beams 208, 209 may be manipulated to form the same focal spot 212.

FIG. 2B depicts an example arrangement of electrodes 218, 220, 224, 226 in an example x-ray tube, such as x-ray tube 200. While only two electrodes 218, 220 were depicted in FIG. 2A, additional electrodes, such as electrodes 224, 226, may also be included to manipulate or control the electron beam 208 and/or electron beam 209. The view depicted in FIG. 2B is an orthogonal view from the schematic view depicted in FIG. 2A. Accordingly, the electron beam 208 may be viewed as coming out of the page. The additional electrodes 224, 226 allow for additional control of the electron beam 208 such that the electron beam 208 may be moved in a second direction. In the example depicted, the first pair of electrodes 218, 220 may be used to move the electron beam 208 in a first direction (e.g., vertical direction) and the second pair of electrodes 224, 226 may be used to move the electron beam in a second direction (e.g., lateral direction). The second pair of electrodes 224, 226 may also be positioned opposite the electron beam path. The second pair of electrodes 224, 226 may positioned such that they are orthogonal to the first pair of electrodes 218, 220. Additional pairs of electrodes may also be added to move the electron beam 208 in different or additional directions as well.

The second pair of electrodes 224, 226 may be controlled by second control signal. For instance, a terminal of the third electrode 224 and the terminal of the fourth electrode 226 may connected to the control signal source as indicated by the Control2+ and Control2− designations in FIG. 2B. The second control signal may be generated and determined in substantially the same manner as the first control signal used to control the first pair of electrodes 218, 220. The first control signal, however, may be different from the second control signal and have different characteristics.

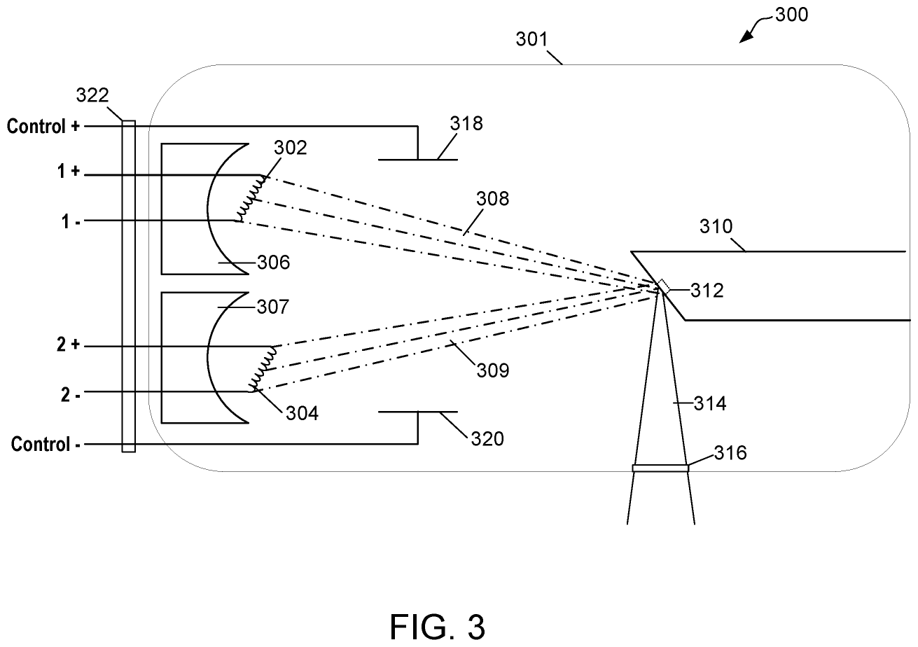

FIG. 3 depicts another example of an x-ray tube 300 having multiple filaments 302, 304. The x-ray tube 300 is similar to the x-ray tube 200 discussed above and depicted in FIGS. 2A-2B, with the exception that the x-ray tube 300 includes two focusing cups 306, 307. The first filament 302 is located adjacent to the first focusing cup 306, and the second filament 304 is located adjacent the second focusing cup 307. In some examples, the cathode assembly of the x-ray tube 300 may include the first focusing cup 306, the first filament 302, the second focusing cup 307, and the second filament 304. The first filament 302 and the second filament 304 may be controlled, activated, and/or engaged in the same manner as discussed above, such as through the use of a switching mechanism 322.

When the first filament 302 is activated, such as by causing a current to flow through the first filament 302, a first electron beam 308 is formed that impacts an anode 310. Similarly, when the second filament 304 is activated, such as by causing a current to flow through the second filament 304, a second electron beam 309 is formed that impacts the anode 310. As with the x-ray tube 200 discussed above, it is desirable that in the x-ray tube 300, depicted in FIG. 3, the first electron beam 308 and the second electron beam 309 have substantially the same focal spot 312 of the anode 310. For instance, the focal spot 312 may have the same size and location on the anode 310. By having the same focal spot 312, the first electron beam 308 and the second electron beam 309 cause a similar x-ray beam 314 to be emitted from the anode 310. Thus, the imaging x-ray beam that exits the window 316 of the tube body 301 does not significantly change when the second filament 304 is engaged upon the failure of the first filament 302.

Causing the first electron beam 308 and the second electron beam 309 to have substantially the same focal spot 312 may be achieved through the configuration of the focusing cups 306, 307 and/or the use of a control signal and electrodes 318, 320. For example, the size, shape, position, charge, and/or charge distribution of the first focusing cup 306 may be selected or configured such that the first electron beam 308 forms the focal spot 312 on the anode 310. The size, shape, position, charge, and/or charge distribution of the second focusing cup 307 may also be selected or configured such that the second electron beam 309 forms substantially the same the focal spot 312 on the anode 310. In addition, or alternatively, a control signal applied to a pair of electrodes 318, 320 may also be used to manipulate the first electron beam 308 and/or the second electron beam 309. The pair of electrodes 318, 320 and the control signal may operate in the same or similar manner as the electrodes 218, 220 discussed above with reference to FIGS. 2A-2B. Additional electrodes and control signals may also be utilized and incorporated into the x-ray tube 300, such as the second pair of electrodes 224, 226 discussed above with reference to FIG. 2B.

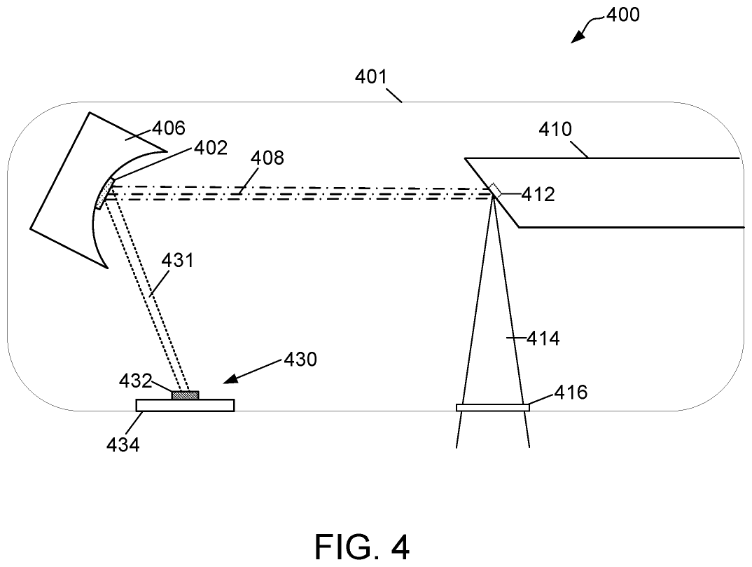

FIG. 4 depicts an example of an x-ray tube 400 having a cathode assembly heated by a laser 430. The x-ray tube 400 includes a tube body 401 housing a cathode assembly including a focusing cup 406 and an electron emitting block 402 positioned adjacent to the focusing cup 406. In some examples, the electron emitting block 402 may be attached to the focusing cup 406. The tube body 401 also houses an anode 410. The electron emitting block 402 is positioned between the focusing cup 406 and the anode 410. The electron emitting block 402 may be a block of material that emits electrons when heated, such as through thermionic emission. In some examples, the electron emitting block 402 may be made from a material with a high melting point. As an example the electron emitting block 402 may be made from primarily from tungsten.

The x-ray tube 400 also includes a laser 430. The laser is configured to emit a laser beam 431 directed at the electron emitting block 402. In some examples, the laser may be a semiconductor laser bar that includes one or more diode lasers 432 attached to a heat sink 434. The diode lasers 432 emit a beam 431 of electromagnetic radiation. The use of a semiconductor laser bar as the type of laser 430 may be beneficial over other types of lasers (e.g., CO₂, fiber, etc.) for several reasons. First, semiconductor laser bars can be incorporated in small packages making it easier to incorporate into the x-ray tube 400. The semiconductor laser bar may also be all solid-state device that will not contaminate other elements inside the x-ray tube 400 and may also be able to better withstand the vacuum environment within the x-ray tube 400.

The electromagnetic radiation generated from the laser 430 may have differing frequencies, such as in the infrared spectrum, the visible spectrum, or the ultraviolet spectrum. The laser beam 431 irradiates a portion of the electron emitting block 402. The portion of the electron emitting block 402 that is illuminated is based on the spot size of the laser beam 431. Focusing optics within the laser 430 or positioned between the laser 430 and electron emitting block 402 may be used to change the spot size of the laser beam 431. By changing the spot size of the laser beam, different portions of the electron emitting block 402 may be heated. For instance, the spot size may be configured to substantially match the size and shape of a filament.

Due to the irradiation of the laser beam 431, the temperature of at least the portion of electron emitting block 402 increases. The increase in temperature causes the thermionic emission of electrons similar to the filaments discussed above. In contrast to the filaments, however, the electron emitting block 402 is not heated by electric current flowing through the electron emitting block 402. Thus, the electron emitting block 402 is able to be substantially larger and more robust than a filament, which leads to a longer lifetime of the x-ray tube 400. For example, the electron emitting block 402 may have a thickness of about 1 mm or larger. The surface area of the electron emitting block 402 facing the laser 430 may also be greater than or equal to about 2 mm, 4 mm, 6 mm, 8 mm, 10 mm, 12 mm, 14 mm, 16 mm, 18 mm, or 20 mm. Increasing the size of the electron emitting block 402 may further increase the lifetime of the x-ray tube 400 because the electron emitting block 402 is less likely to degrade and fail over time.

In some examples, depending on the type of material(s) of the electron emitting block 402 and/or the wavelength of the electromagnetic radiation emitted from the laser 430, photoelectric emission of electrons may also occur. As an example, where the electron emitting block 402 includes tungsten, electromagnetic radiation having a wavelength of less than 272 nm, such as some ultraviolet light, may cause photoelectric emission of electrons from the tungsten in the electron emitting block 402. Total electron emission may be increased where thermionic and photoelectric emission occurs. Accordingly, the wavelength of the laser 430 may be selected based on the type of material used in the electron emitting block 402, or the type of material used in the electron emitting block 402 may be selected based on the wavelength of the laser 430. In either case, the wavelength of the electromagnetic radiation emitted from the laser 430 may be less than the photoelectric threshold (e.g., the threshold wavelength that causes photoelectric electron emission) of a material, such as the primary or majority material, used to make the electron emitting block 402. In some examples, the material is the primary or majority material used to make the electron emitting block 402.

Due a voltage difference between the cathode assembly and the anode 410, the electrons emitted from the electron emitting block 402 are accelerated towards the anode 410. The accelerated electrons form an electron beam 408 that travel along an electron beam path. The electron beam 408 impacts the anode 410, which causes the emission of x-rays 414 from the anode 410. The x-rays 414 exit the x-ray tube body 401 through a tube window 416. The x-rays 414 that exit through the window 416 form the x-ray beam that is used for imaging, such as x-ray beam 120 discussed above with reference to FIGS. 1A-1B.

The area in which the electron beam 408 impacts the anode 410 is referred to as the focal spot 412, as discussed above. The size, shape, and location of the focal spot 412 may be altered by altering the focusing cup 406. For example, modifying the size, shape, position, charge, and/or charge distribution of the focusing cup 406 may alter the electron beam 408 to form a desired focal spot 412. In addition, the spot size of the laser beam 431 may also alter the focal spot 412. For instance, a larger spot size of the laser beam 431 may result in a larger focal spot 412. In addition electrodes and a control signal, such as those discussed above, may also be incorporated into the x-ray tube 400 to further manipulate the electron beam 408 and the focal spot 412.

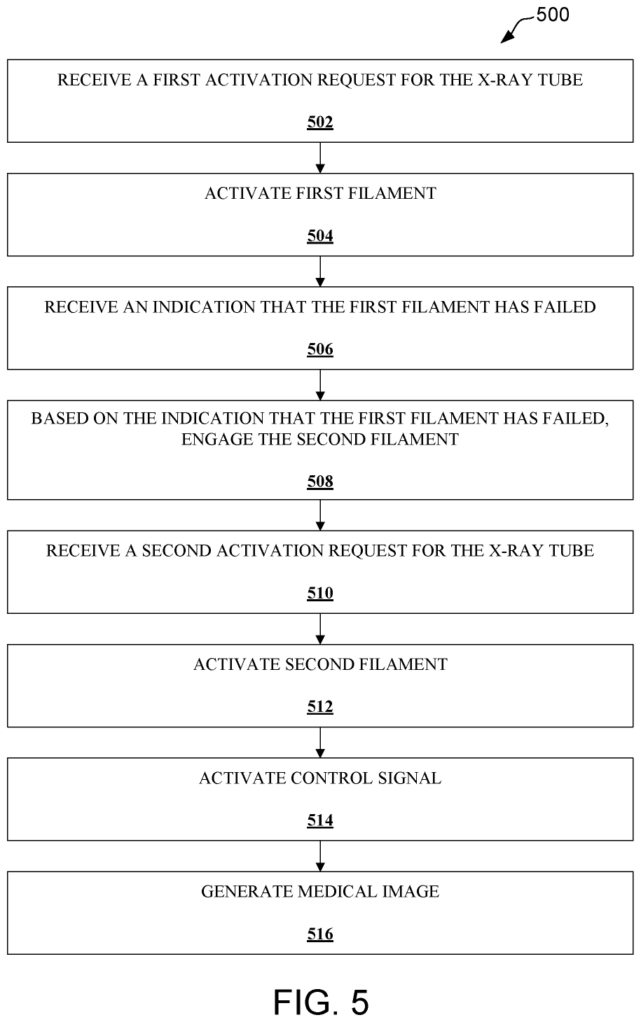

FIG. 5 depicts an example method 500 for controlling an x-ray tube. At operation 502, a first activation request for the x-ray tube is received. The first activation request may be a request to generate x-rays for imaging a patient. For example, the activation request may be generated when a mammography image or a tomography projection image is to be acquired. In response to receiving the first activation request for the x-ray tube, a first filament in the x-ray tube is activated at operation 504. Activating the first filament may include applying a voltage across the first filament. When the first filament is in a non-failed state, application of the voltage across the first filament causes a current to flow through the first filament. The current heats the first filament and may cause thermionic emission of electrons from the first filament. As discussed above, the emitted electrons from the first filament accelerate towards an anode of the x-ray tube which causes the production of the x-rays. The x-rays that leave the x-ray tube through an x-ray tube window form a first x-ray imaging beam. Activation of the first filament may also include additional operations such as activating additional components of the medical imaging system or the x-ray tube, such as establishing a high voltage difference between the cathode assembly and the anode of the x-ray tube.

At operation 506, an indication is received that the first filament has failed. The first filament may fail for multiple reasons. When the filament fails, however, the first filament generally creates an open circuit or abnormally high resistance between the terminals of the filament. Thus, current is effectively prevented from flowing through the first filament. The lack of current flowing when a voltage is applied across the failed first filament may be detected and used as a trigger signal, which may be the indication received in operation 506. The trigger signal may also be generated based on, or be representative of, an abnormally high resistance of the failed first filament. The indication that the first filament has failed may also generate a warning, such as a visual or audible indicator, for the technician.

At operation 508, a back-up or second filament of the x-ray tube is engaged based on the indication that the first filament has failed. The back-up or second filament of the x-ray tube may have substantially the same size and shape as the first filament. Engaging the second filament may include processing the trigger signal by software or firmware in a medical imaging system, which may then cause the second filament to engage via a switching mechanism. The trigger signal may also be used to engage the second filament without the use of software or firmware. For instance, the trigger signal may be provided to one or more transistors and/or relays that switch the connection of the voltage source from the terminals of the first filament to the terminals of the second filament. In addition, a mechanical switch may also be utilized to engage the second filament. The mechanical switch may be switched automatically or manually. For example, a technician, upon seeing or hearing an indicator that the first filament has failed, may switch the mechanical switch to engage the second filament.

At operation 510, a second request for activation of the x-ray tube is received. The second request may be similar to the first request that was received in operation 502. For example, the second activation request may be a request to generate x-rays for imaging a patient. For example, the second activation request may be generated when a subsequent mammography image or a subsequent tomography projection image is to be acquired. At operation 512, in response to receiving the second activation request for the x-ray tube, the second filament is activated at operation 504. Activation of the second filament may be similar to activation of the first filament. For example, activating the second filament may include applying a voltage across the second filament. Application of the voltage across the second filament causes a current to flow through the second filament. The current heats the second filament and may cause thermionic emission of electrons from the second filament. As discussed above, the emitted electrons from the second filament accelerate towards an anode of the x-ray tube which causes the production of the x-rays. The x-rays that leave the x-ray tube through an x-ray tube window form a second x-ray imaging beam. The second imaging beam may substantially similar to, if not the same as, the first imaging beam generating from activating the first filament. As discussed above, the electron beams produced by the first filament and the second filament may be manipulated such that the focal spot for both electron beams is the substantially the same. Accordingly, the x-ray imaging beams produced by the electron beams may be substantially the same.

At operation 514, a control signal may be applied across at least one pair of electrodes positioned opposite an electron beam path of the x-ray tube. The control signal may manipulate the electron beam produced by the second filament, as discussed above. In some examples, the control signal may be activated concurrently with the activation of the second filament in operation 512. At operation 516, a medical image may be generated based on the second x-ray imaging beam. For example, the second x-ray imaging beam may be detected by a detector or receptor after passing through a portion of a patient. The detector may convert the attenuated second x-ray beam into an electrical signal that is then converted to a medical image.

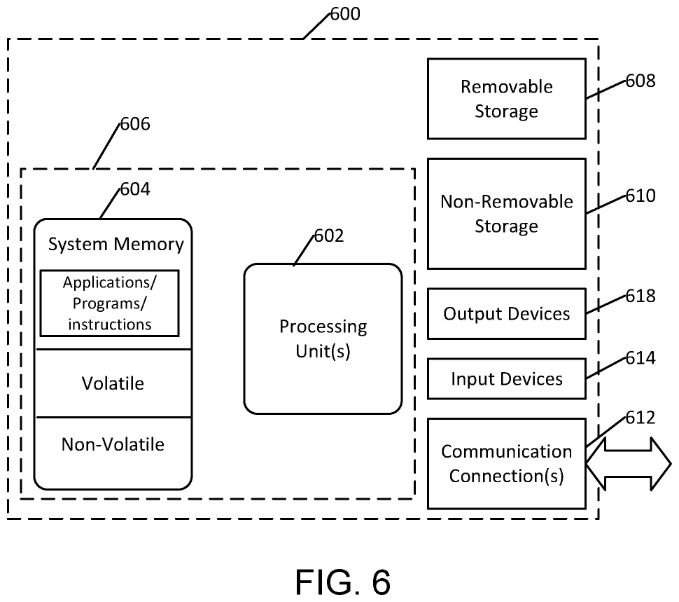

FIG. 6 illustrates an exemplary suitable operating environment for controlling an x-ray tube. In its most basic configuration, operating environment 600 typically includes at least one processing unit 602 and memory 604. Depending on the exact configuration and type of computing device, memory 604 (storing, instructions to perform the x-ray tube control techniques disclosed herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, solid-state, magnetic or optical disks, or tape. Similarly, environment 600 may also have input device(s) 614 such as keyboard, mouse, pen, voice input, etc. and/or output device(s) 616 such as a display, speakers, printer, etc. Also included in the environment may be one or more communication connections 612, such as LAN, WAN, point to point, etc. In embodiments, the connections may be operable to facility point-to-point communications, connection-oriented communications, connectionless communications, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. For instance, while the present disclosure primarily discussed having only one backup filament, additional backup filaments may also be included in the x-ray tube to further prolong the lifetime of the x-ray tube. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent.

Although specific embodiments are described herein, the scope of the technology is not limited to those specific embodiments. One skilled in the art will recognize other embodiments or improvements that are within the scope and spirit of the present technology. In addition, one having skill in the art will recognize that the various examples and embodiments described herein may be combined with one another. Therefore, the specific structure, acts, or media are disclosed only as illustrative embodiments. The scope of the technology is defined by the following claims and any equivalents therein.

What is claimed is:

1. An x-ray tube comprising:
a focusing cup;
an anode;
a first filament positioned in a first location between the focusing cup and the anode, the first filament having a first size;
a second filament positioned in a second location between the focusing cup and anode, the second filament having a second size that is substantially the same as the first size; and
a switching mechanism configured to engage the second filament upon failure of the first filament.

2. The x-ray tube of claim 1, further comprising a first electrode and a second electrode positioned between the second filament and the anode, wherein the first electrode is positioned opposite an electron beam path from the second electrode.

3. The x-ray tube of claim 2, wherein the first electrode and the second electrode are configured to, when a first control signal is applied across the first and second electrode, generate an electric field that moves an electron beam in a first direction.

4. The x-ray tube of claim 3, wherein:
the first filament is configured to generate a first electron beam having a first focal spot on the anode;
the second filament is configured to generate a second electron beam; and
the first control signal is configured to move the second electron beam such that the second electron beam has a second focal spot on the anode that is substantially the same as the first focal spot.

5. The x-ray tube of claim 4, further comprising a third electrode and a fourth electrode, wherein the third electrode and the fourth electrode are configured to, when a second control signal is applied across the third and the fourth electrode, generate an electric field that moves the electron beam in a second direction.

6. The x-ray tube of claim 1, wherein the switching mechanism is a mechanical switch.

7. The x-ray tube of claim 1, wherein the switching mechanism includes at least one transistor or relay configured to automatically engage the second filament upon the failure of the first filament.

8. An x-ray tube comprising:
a first focusing cup;
a second focusing cup;
an anode;
a first filament located between the first focusing cup and the anode;
a second filament positioned between the second focusing cup and the anode; and
a switching mechanism configured to engage the second filament upon failure of the first filament.

9. The x-ray tube of claim 8, further comprising a first electrode and a second electrode positioned between the second filament and the anode, wherein the first electrode is positioned opposite an electron beam path from the second electrode.

10. The x-ray tube of claim 9, wherein the first electrode and the second electrode are configured to, when a first control signal is applied across the first and second electrode, generate an electric field that moves an electron beam in a first direction.

11. The x-ray tube of claim 10, wherein:
the first filament is configured to generate a first electron beam having a first focal spot on the anode;
the second filament is configured to generate a second electron beam; and
the first control signal is configured to move the second electron beam such that the second electron beam has a second focal spot on the anode that is substantially the same as the first focal spot.

12. The x-ray tube of claim 8, wherein
the first filament is configured to generate a first electron beam having a first focal spot on the anode;
the second filament is configured to generate a second electron beam; and
the first focusing cup and the second focusing cup are positioned such that the second electron beam has a second focal spot on the anode that is substantially the same as the first focal spot.

13. The x-ray tube of claim 8, wherein the switching mechanism is a mechanical switch.

14. A method for producing x-rays from an x-ray tube, the method comprising:
receiving a first activation request for the x-ray tube;
activating a first filament in the x-ray tube to generate a first x-ray imaging beam;
receiving an indication that the first filament has failed;
based on the indication that the first filament has failed, engaging a second filament in the x-ray tube;
receiving a second activation request for the x-ray tube; and
activating a second filament in the x-ray tube to generate a second x-ray imaging beam that is substantially similar the first x-ray imaging beam.

15. The method of claim 14, wherein activating the first filament comprises applying a voltage across the first filament.

16. The method of claim 14, wherein activating the second filament comprises applying a voltage across the second filament.

17. The method of claim 14, wherein engaging the second filament comprises switching a mechanical switch.

18. The method of claim 14, wherein the indication that the first filament has failed is a trigger signal generated based on a high resistance of the first filament.

19. The method of claim 14, further comprising activating a control signal applied across at least one pair of electrodes positioned opposite an electron beam path of the x-ray tube.

20. The method of claim 19, wherein the control signal is activated concurrently with the activation of the second filament.
